(19) United States
(12) Patent Application Publication
(10) Pub. No.: US 2025/0141265 A1
(43) Pub. Date: May 1, 2025

(54) POWER RECEIVING DEVICE

(71) Applicant: TOYODA GOSEI CO., LTD., Kiyosu-shi (JP)

(72) Inventors: Yuki TOKUYAMA, Kiyosu-shi (JP); Atsushi SUGIHARA, Kiyosu-shi (JP); Shinichiro FUKI, Kiyosu-shi (JP)

(21) Appl. No.: 18/928,869

(22) Filed: Oct. 28, 2024

(30) Foreign Application Priority Data
Oct. 30, 2023 (JP) 2023-185387

(51) Int. Cl. H02J 50/00; H02J 50/27

(52) U.S. Cl. CPC H02J 50/005; H02J 50/27

(57) ABSTRACT

A power receiving device includes plural antenna groups each including at least one antenna to receive a power transmission signal transmitted for contactless power transfer from a power transmitting device and respectively having different directivities, a transmitter that transmits a beacon signal to the power transmitting device for each of the antenna groups, a switching unit that switches to a receiving antenna group to receive the power transmission signal that is selected from the antenna groups, and a control unit that searches for the receiving antenna group for which a power value obtained by converting the power transmission signal transmitted from the power transmitting device based on the transmission of the beacon signal is not less than a predetermined threshold value, retransmits the beacon signal corresponding to the searched receiving antenna group, and charges a charging target by receiving the power transmission signal transmitted toward the receiving antenna group.

### CROSS-REFERENCE TO RELATED APPLICATIONS

The present patent application claims the priority of Japanese patent application No. 2023/185387 filed on Oct. 30, 2023, and the entire contents of Japanese patent application No. 2023/185387 are hereby incorporated by reference.

### TECHNICAL FIELD

The present invention relates to a power receiving device.

### BACKGROUND ART

A wireless power transmitting and receiving system is known which includes a power transmitting device that outputs microwaves and a power receiving device that converts the received microwaves into electric power for charging (see, e.g., PTL 1).

The power transmitting device of the wireless power transmitting and receiving system can adjust the phase of microwaves based on a beacon signal output from the power receiving device, and direct the microwaves toward the power receiving device.

### CITATION LIST

### Patent Literature

PTL 1: WO 2021/059453

### SUMMARY OF INVENTION

In the wireless power transmitting and receiving system, the orientation of the antenna of the power receiving device relative to the power transmitting device affects power reception efficiency, so there is a limit to how much power reception efficiency can be improved by only directing the directivity of the microwaves toward the power receiving device.

It is an object of the invention to provide a power receiving device that can improve power reception efficiency.

One aspect of the invention provides a power receiving device, comprising:
a plurality of antenna groups each comprising at least one antenna to receive a power transmission signal transmitted for contactless power transfer from a power transmitting device and respectively having different directivities;
a transmitter that transmits a beacon signal to the power transmitting device for each of the plurality of antenna groups;
a switching unit that switches to a receiving antenna group to receive the power transmission signal that is selected from the plurality of antenna groups; and
a control unit that controls the transmitter and the switching unit, searches for the receiving antenna group for which a power value obtained by converting the power transmission signal transmitted from the power transmitting device based on the transmission of the beacon signal for each of the plurality of antenna groups is not less than a predetermined threshold value, retransmits the beacon signal corresponding to the searched receiving antenna group, and charges a charging target by receiving the power transmission signal transmitted toward the receiving antenna group.

### ADVANTAGEOUS EFFECTS OF INVENTION

According to an embodiment of the invention, it is possible to improve power reception efficiency.

### BRIEF DESCRIPTION OF DRAWINGS

FIG. 1A is a diagram illustrating an example of a power receiving device in a first embodiment.

FIG. 1B is a side view showing an example of an antenna.

FIG. 2 is an example of a block diagram illustrating a power transmission system in the first embodiment.

FIG. 3 is an example of a timing chart of the power receiving device in the first embodiment when searching for a receiving antenna group among all antenna groups.

FIG. 4 is an example of a timing chart of the power receiving device in the first embodiment when performing the search for a receiving antenna group starting with an antenna group that had the largest power value at the time of previous charging.

FIG. 5A is a diagram illustrating an example of a power receiving device in a second embodiment.

FIG. 5B is a diagram illustrating an example of plural antennas constituting an antenna group.

FIG. 6 is an example of a block diagram illustrating a power transmission system in a third embodiment.

FIGS. 7A and 7B are diagrams illustrating an example of antenna groups opposite to each other in a fourth embodiment.

FIG. 7C is a diagram illustrating an example in which the antenna groups are not opposite to each other.

FIGS. 8A and 8B are diagrams illustrating an example of plural combination groups of a power receiving device in a fifth embodiment.

### DESCRIPTION OF EMBODIMENTS

### Summary of the Embodiments

The power receiving device in the embodiments generally includes plural antenna groups each being composed of at least one antenna to receive a power transmission signal transmitted for contactless power transfer from a power transmitting device and respectively having different directivities, a transmitter that transmits a beacon signal to the power transmitting device for each of the plural antenna groups, a switching unit that switches to a receiving antenna group to receive the power transmission signal that is selected from the plurality of antenna groups, and a control unit that controls the transmitter and the switching unit, searches for the receiving antenna group for which a power value obtained by converting the power transmission signal transmitted from the power transmitting device based on the transmission of the beacon signal for each of the plural antenna groups is not less than a predetermined threshold value, retransmits the beacon signal corresponding to the searched receiving antenna group, and charges a charging target by receiving the power transmission signal transmitted toward the receiving antenna group.

The power receiving device searches for a receiving antenna group among antenna groups respectively having different directivities. Therefore, it is possible to suppress the influence of the orientation of the receiving antenna group of the power receiving device relative to the power transmitting device and thereby improve power reception efficiency, as compared to when using at least one of antennas with the same directivity. In this regard, the power reception efficiency is a ratio of actually converted power to power when a transmitted power transmission signal is converted without loss.

### First Embodiment

### General Configuration of a Power Receiving Device 1

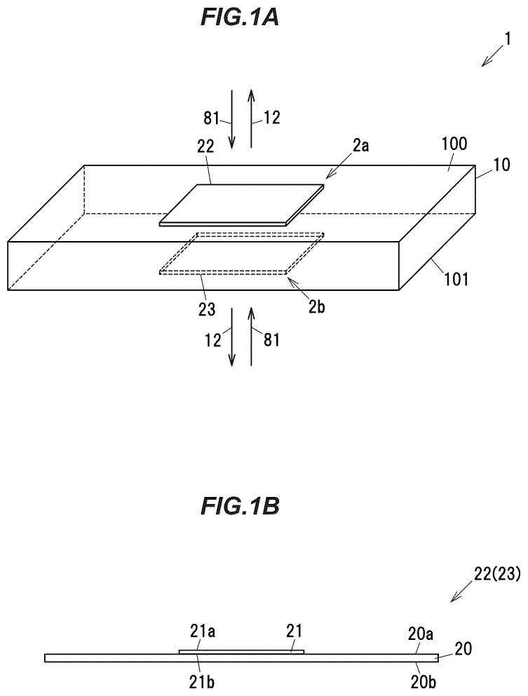

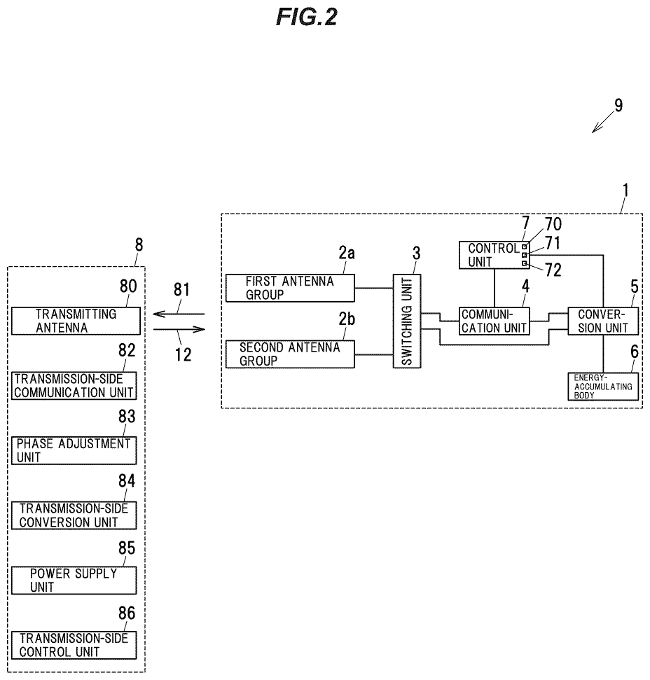

FIG. 1A is a diagram illustrating an example of a power receiving device in the first embodiment, and FIG. 1B is a side view showing an example of an antenna. FIG. 2 is an example of a block diagram illustrating a power transmission system in the first embodiment. In the drawings of the embodiments described below, a scale ratio or shape may be different between the drawings or different from an actual ratio or shape. In addition, “A-B” indicating the numerical range shall be used to mean “not less than A and not more than B”.

A power transmission system 9 is configured such that charging takes place without the user paying attention of it when the power receiving device 1 receives a power transmission signal transmitted from a power transmitting device 8. In this power receiving device 1, antenna groups are arranged on a housing 10. The housing 10 is a housing of an electronic device such as a smartphone, a tablet terminal, a personal computer, a drone, a remote controller, a mobile battery and an electronic key as an example, but is not limited thereto. The power receiving device 1 may be configured, e.g., to be connected to these electronic devices through a harness, etc.

In particular, as shown in FIGS. 1A to 2, the power receiving device 1 generally includes plural antenna groups each being composed of at least one antenna to receive a power transmission signal transmitted for contactless power transfer from the power transmitting device 8 and respectively having different directivities, a communication unit 4 as the transmitter that transmits a beacon signal 12 to the power transmitting device 8 for each of the plural antenna groups, a switching unit 13 that switches to a receiving antenna group to receive the power transmission signal that is selected from the plural antenna groups, and a control unit 7 that controls the communication unit 4 and the switching unit 3, searches for the receiving antenna group for which a power value obtained by converting the power transmission signal transmitted from the power transmitting device 8 based on the transmission of the beacon signal 12 for each of the plural antenna groups is not less than a predetermined threshold value 70, retransmits the beacon signal 12 corresponding to the searched receiving antenna group, and charges an energy-accumulating body 6 as a charging target by receiving the power transmission signal transmitted toward the receiving antenna group. As an example, the power receiving device 1 further includes a conversion unit 5 as shown in FIG. 2. In searching for a receiving antenna group, when electric power with a power value of not less than the threshold value 70 is obtained from an antenna group and there are still antenna groups scheduled to be switched, the power receiving device 1 sets this antenna group as the receiving antenna group and does not need to switch to other antenna groups.

The antenna groups in the first embodiment are a first antenna group 2a and a second antenna group 2b. The first antenna group 2a and the second antenna group 2b are each composed of one patch antenna 21, but are not limited thereto, and each may be composed of plural patch antennas 21.

As an example, the power transmitting device 8 in the first embodiment transmits power using microwave 81 as the power transmission signal. In this regard, the power transmission method of the power transmission device 8 is not limited to the method using the microwaves 81, and may be a laser method using laser light, etc.

As an example, the power transmitting device 8 generally includes a transmitting antenna 80, a transmission-side communication unit 82, a phase adjustment unit 83, a transmission-side conversion unit 84, a power supply unit 85 and a transmission-side control unit 86, as shown in FIG. 2.

The transmitting antenna 80 is an antenna used to transmit the microwaves 81 to the power receiving device 1 and to receive the beacon signals 12 transmitted from the power receiving device 1. The transmission-side communication unit 82 transmits the microwaves 81 and receives the beacon signals 12 through the transmitting antenna 80. The phase adjustment unit 83 adjusts the phase of the microwaves 81 based on the reception of the beacon signals 12 so that the microwaves 81 travel in the direction from which the beacon signals 12 are transmitted. The transmission-side conversion unit 84 converts power from the power supply unit 85 into the microwaves 81. The power supply unit 85 supplies power to be converted into the microwaves 81. The power supply unit 85 may be configured to use power supplied from an external power source, or may be configured as a storage battery.

The microwave 81 has a frequency of 900 MHz-60 GHz as an example, but it is not limited thereto.

The transmission-side control unit 86 is, e.g., a microcomputer composed of a CPU (Central Processing Unit) performing calculation and processing, etc., of the acquired data according to a stored program, and a RAM (Random Access Memory) and a ROM (Read Only Memory) as semiconductor memories, etc. The transmission-side control unit 86 is configured to control the transmission-side communication unit 82, the phase adjustment unit 83, the transmission-side conversion unit 84 and the power supply unit 85.

### Configuration of the First Antenna Group 2a and the Second Antenna Group 2b

As shown in FIG. 1B, a first antenna 22 and a second antenna 23 in the first embodiment each include a substrate 20 and the patch antenna 21. The first antenna 22 and the second antenna 23 are used for both transmitting the beacon signal 12 and receiving the microwave 81. Since the first antenna 22 and the second antenna 23 have the same configuration, the first antenna 22 will be described in the following description.

The substrate 20 is a rigid substrate, as an example. The patch antenna 21 is constructed as a thin film of a conductive metal such as copper and formed on a front surface 20a of the substrate 20, as an example. The patch antenna 21 has a rectangular shape, as an example. The patch antenna 21 is configured such that the thin film of a conductive metal is plated with gold or nickel, as an example. The directivity of the patch antenna 21 is mainly in the direction normal to a front surface 21a.

As shown in FIG. 1A, the first antenna group 2a is arranged on a front surface 100 of the housing 10. The second antenna group 2b is arranged on a back surface 101 opposite to the front surface 100. The search for the receiving antenna group is performed starting with, e.g., the first antenna group 2a on the front surface 100, which is highly likely to be located on the upper side when the power receiving device 1 is placed, and then the second antenna group 2b on the back surface 101.

The patch antennas 21 of the first antenna group 2a and the second antenna group 2b in the first embodiment have the same shape and are arranged opposite each other, but are not limited thereto and may have different shapes or may be out of alignment. The first antenna group 2a and the second antenna group 2b are connected to the

switching unit 3. One of the first antenna group 2a and the second antenna group 2b serves as the receiving antenna group by switching by the switching unit 3. When, e.g., the first antenna group 2a is connected to the communication unit 4 through the switching unit 3, the first antenna group 2a serves as the receiving antenna group. Then, when, e.g., the second antenna group 2b is connected to the communication unit 4 through the switching unit 3, the second antenna group 2b serves as the receiving antenna group.

The directivity of the patch antenna 21 is in the direction normal to the front surface 21a. Because of the presence of the substrate 20, efficiency of receiving the microwave 81 reaching the patch antenna 21 from the back surface 21b side is extremely lower than efficiency of receiving the microwave 81 reaching from the front surface 21a side, or power reception is impossible.

For this reason, the first antenna group 2a and the second antenna group 2b are arranged opposite each other to have different directivities, so that one of the antenna groups can receive the microwave 81 directed toward the front surface 20a of the substrate 20, not the microwave 81 directed toward the back surface 20b of the substrate 20.

### Configuration of the Switching Unit 3

The switching unit 3 is configured to switch an antenna group to receive the microwave 81 and an antenna group to transmit the beacon signal 12.

### Configuration of the Communication Unit 4

The communication unit 4 is configured to transmit the beacon signal 12 using at least one of the antennas in the antenna group. The antennas in the first embodiment are the first antenna 22 of the first antenna group 2a and the second antenna 23 of the second antenna group 2b. Therefore, the communication unit 4 transmits the beacon signal 12 using the first antenna 22 and the second antenna 23.

The communication unit 4 is configured to receive the microwave 81 and transmit the beacon signal 12 under the control of the control unit 7. As a modification, the power receiving device 1 may have a mode in which the conversion unit 5 is directly connected to the switching unit 3 without through the communication unit 4 and charges the energy-accumulating body 6 during reception, as an example. This mode is a mode for recovery purposes in which the received microwaves 81 are directly rectified by the rectifier circuit of the conversion unit 5 to charge the energy-accumulating body 6 when power to operate the communication unit 4 and the control unit 7 is not sufficiently stored in the energy-accumulating body 6, as an example.

### Configuration of the Conversion Unit 5

The conversion unit 5 has the rectifier circuit and converts the microwave 81 received by the first antenna group 2a and the second antenna group 2b into a DC current. The conversion unit 5 is arranged after the switching unit 3 as an example, but is not limited thereto and may be arranged between the first antenna group 2a and the switching unit 3, and between the second antenna group 2b and the switching unit 3. Furthermore, the conversion unit 5 may be directly connected to the switching unit 3, as described above. The conversion unit 5 is arranged on the back surface 20b of the substrate 20 as an example, but it is not limited thereto.

When the switching unit 3 and the conversion unit 5 are arranged on the substrate 20, the first antenna group 2a, the second antenna group 2b, the switching unit 3 and the conversion unit 5 are close to each other, hence, the power receiving device 1 can suppress a decrease in power reception efficiency as compared to when these components are far apart.

In addition, when plural antenna groups are close to each other and the rectifier circuit of the conversion unit 5 can be placed after the switching unit 3, the power receiving device 1 have fewer components and it is thereby possible to suppress the manufacturing cost, as compared to the case where this configuration is not adopted.

### Configuration of the Energy-Accumulating Body 6

The energy-accumulating body 6 is, e.g., a rechargeable battery such as a lithium-ion battery, a nickel-metal hydride battery, or a nickel-cadmium battery. The energy-accumulating body 6 in the first embodiment is a lithium-ion battery as an example, but is not limited thereto. The energy-accumulating body 6 is charged by the microwave 81 transmitted from the power transmitting device 8.

### Configuration of the Control Unit 7

The control unit 7 is, e.g., a microcomputer composed of a CPU, a RAM, and a ROM, etc. The control unit 7 has the threshold value 70, power value information 71, and antenna information 72.

The threshold value 70 is compared against a power value obtained by converting the received microwave 81. As an example, this power value may be an average power value over a predetermined period of time, or may be an integrated value over a predetermined period of time. When the power value is an average value, the threshold value 70 is set to a value greater than the average power consumption of the power receiving device 1 over a predetermined period of time, as an example. When the power value is an integrated value, the threshold value 70 is set to a value greater than the integrated value of the power consumption of the power receiving device 1 over a predetermined period of time, as an example. In other words, the threshold value 70 is set based on whether or not the power value is greater than the power consumption and the energy-accumulating body 6 can be charged.

The control unit 7 is configured to store the power values obtained from the microwaves 81 received by the plural antenna groups, and when searching for the receiving antenna group, transmit the beacon signal 12 from the antenna group that had the largest power value at the time of previous charging. The term “searching for the receiving antenna group” means, e.g., the power receiving device 1 searches for a receiving antenna group with high power reception efficiency to start charging. The control unit 7 stores a power value history of each antenna group as the power value information 71.

When transmitting the beacon signal 12 to charge the energy-accumulating body 6, the control unit 7 transmits the beacon signal 12 from an antenna group that had a large power value at the time of previous charging, based on the power value information 71. Then, when the power value obtained from the microwave 81 received by that antenna group is not less than the threshold value 70, the control unit 7 ends the search and sets this antenna group as the receiving antenna group.

As a modification, the control unit 7 may be configured to transmit the beacon signal 12 from the previous receiving antenna group based on the power value information 71 when searching for the receiving antenna group. As another modification, the control unit 7 may store the power values from the previous search as the power value information 71, and based on this power value information 71, perform the search starting with an antenna group with the highest power reception efficiency. As yet another modification, the control unit 7 may refer to how frequently each antenna group is set as the receiving antenna group based on the power value information 71, and transmit the beacon signal 12 in the order of the antenna groups from the highest frequency in descending order.

The control unit 7 has the antenna information 72 about the first antenna group 2a and the second antenna group 2b. The antenna information 72 includes, e.g., information on which order the antenna groups transmit the beacon signal 12 as an initial value.

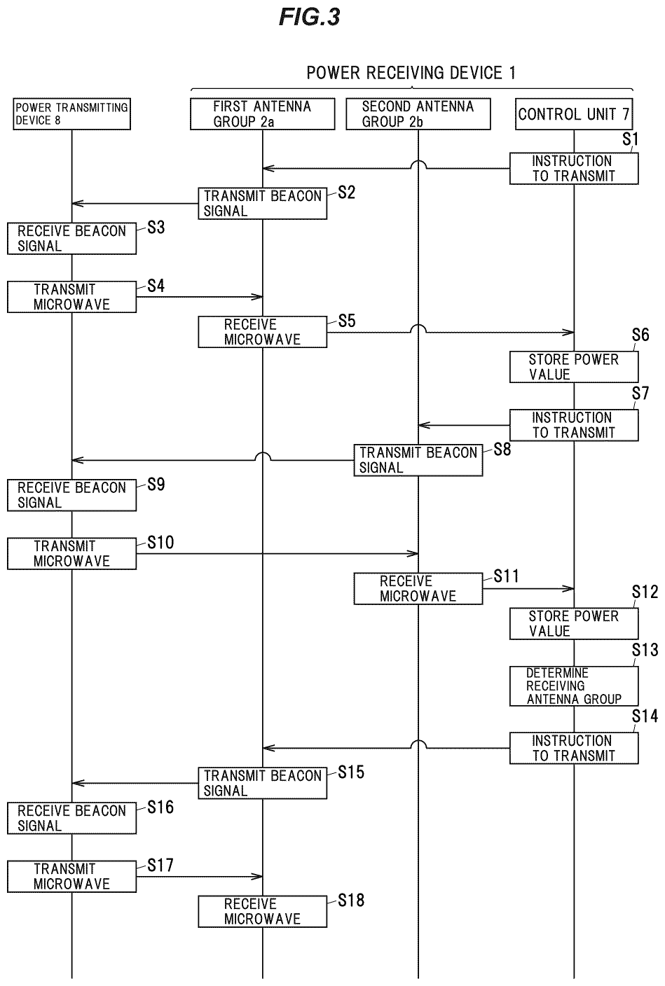

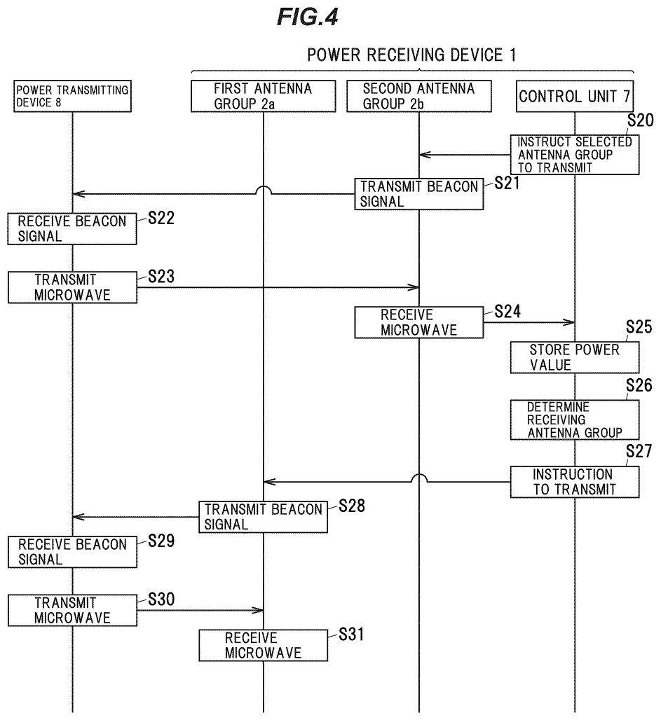

FIG. 3 is an example of a timing chart when searching for the receiving antenna group among all antenna groups. FIG. 4 is an example of a timing chart when performing the search for the receiving antenna group starting with an antenna group that had the largest power value at the time of previous charging. First, an example of an operation in which the power receiving device 1 searches for the receiving antenna group among all antenna groups, which is the default setting, will be described below according to the timing chart of FIG. 3.

### Operation

To search for the receiving antenna group, the control unit 7 of the power receiving device 1 controls the switching unit 3 and the communication unit 4 and issues an instruction to transmit the beacon signal 12 from the first antenna group 2a (Step 1). The switching unit 3 connects the first antenna group 2a to the communication unit 4.

The first antenna group 2a transmits the beacon signal 12 (Step 2).

When the power transmitting device 8 receives the beacon signal 12 (Step 3), the power transmitting device 8 adjusts the phase so that the directivity of the microwave 81 is large in the direction of the beacon signal 12, and then transmits the microwave 81 (Step 4).

The first antenna group 2a receives the microwave 81 transmitted from the power transmitting device 8 (Step 5). The conversion unit 5 obtains the microwave 81 received by the first antenna group 2a through the communication unit 4 and converts the microwave 81 into electrical power. The control unit 7 stores the power value of the converted power as the power value information 71 (Step 6).

The control unit 7 controls the switching unit 3 and the communication unit 4 and issues an instruction to transmit the beacon signal 12 from the second antenna group 2b (Step 7). The switching unit 3 switches the connection from the first antenna group 2a to the second antenna group 2b to connect the second antenna group 2b to the communication unit 4.

The second antenna group 2b transmits the beacon signal 12 (Step 8).

When the power transmitting device 8 receives the beacon signal 12 (Step 9), the power transmitting device 8 adjusts the phase so that the directivity of the microwave 81 is large in the direction of the beacon signal 12, and then transmits the microwave 81 (Step 10).

The second antenna group 2b receives the microwave 81 transmitted from the power transmitting device 8 (Step 11). The conversion unit 5 obtains the microwave 81 received by the second antenna group 2b through the communication unit 4 and converts the microwave 81 into electrical power. The control unit 7 stores the power value of the converted power as the power value information 71 (Step 12).

The control unit 7 compares the stored power values of the first antenna group 2a and the second antenna group 2b against the threshold value 70, based on the power value information 71. When, e.g., the power value of the first antenna group 2a is not less than the threshold value 70, the control unit 7 determines the first antenna group 2a to be the receiving antenna group (Step 13). If both values are not less than the threshold value 70, the control unit 7 sets the antenna group from which the larger power value is obtained, as the receiving antenna group.

Since the control unit 7 has determined that the first antenna group 2a is the receiving antenna group, the control unit 7 controls the switching unit 3 and the communication unit 4 and issues an instruction to transmit the beacon signal 12 from the first antenna group 2a again (Step 14). The switching unit 3 connects the first antenna group 2a to the communication unit 4.

The first antenna group 2a transmits the beacon signal 12 (Step 15).

When the power transmitting device 8 receives the beacon signal 12 (Step 16), the power transmitting device 8 adjusts the phase so that the directivity of the microwave 81 is large in the direction of the beacon signal 12, and then transmits the microwave 81 (Step 17).

The first antenna group 2a receives the microwave 81 transmitted from the power transmitting device 8 (Step 18). The conversion unit 5 obtains the microwave 81 received by the first antenna group 2a through the communication unit 4 and converts the microwave 81 into electrical power to charge the energy-accumulating body 6.

Next, an example of the operation when the power receiving device 1 transmits the beacon signal 12 from the antenna group which had the largest power value at the time of previous charging will be described according to the timing chart of FIG. 4. This antenna group is the second antenna group 2b, as an example.

The control unit 7 of the power receiving unit 1 issues an instruction to transmit the beacon signal 12 from the second antenna group 2b selected as the antenna group which had the largest power value at the time of previous charging, based on the power value information 71 (Step 20). When the switching unit 3 is not connected to the second antenna group 2b, the control unit 7 connects the switching unit 3 to the second antenna group 2b.

The second antenna group 2b transmits the beacon signal 12 (Step 21).

When the power transmitting device 8 receives the beacon signal 12 (Step 22), the power transmitting device 8 adjusts the phase so that the directivity of the microwave 81 is large in the direction of the beacon signal 12, and then transmits the microwave 81 (Step 23).

The second antenna group 2b receives the microwave 81 transmitted from the power transmitting device 8 (Step 24). The conversion unit 5 obtains the microwave 81 received by the second antenna group 2b through the communication unit 4 and converts the microwave 81 into electrical power. The control unit 7 stores the power value of the converted power as the power value information 71 (Step 25).

When the power value of the second antenna group 2b is not less than the threshold value 70, the control unit 7 determines the second antenna group 2b to be the receiving antenna group (Step 26).

Since the control unit 7 has determined that the second antenna group 2b is the receiving antenna group, the control unit 7 controls the switching unit 3 and the communication unit 4 and issues an instruction to transmit the beacon signal 12 from the second antenna group 2b again (Step 27).

The second antenna group 2b transmits the beacon signal 12 (Step 28).

When the power transmitting device 8 receives the beacon signal 12 (Step 29), the power transmitting device 8 adjusts the phase so that the directivity of the microwave 81 is large in the direction of the beacon signal 12, and then transmits the microwave 81 (Step 30).

The second antenna group 2b receives the microwave 81 transmitted from the power transmitting device 8 (Step 31). The conversion unit 5 obtains the microwave 81 received by the second antenna group 2b through the communication unit 4 and converts the microwave 81 into electrical power to charge the energy-accumulating body 6.

The communication unit 4 may be configured to transmit a beacon signal 12 including information indicating that the signal is for searching for the receiving antenna group. In this case, when the power transmitting device 8 receives the beacon signal 12 for the search, the power transmitting device 8 identifies that it is a test beacon signal to search for the receiving antenna group and is not for charging purposes, and the power transmitting device 8 transmits the microwave 81 for a shorter period than the microwave 81 for the charging purpose.

When the beacon signal 12 is a test beacon signal, the microwave 81 is transmitted in approximately 1 ms as an example, whereas transmission in response to the normal beacon signal 12 is in 10-80 ms. Therefore, power consumption of the power transmitting device 8 is suppressed.

### Effects of the First Embodiment

The power receiving device 1 in the first embodiment can improve the power reception efficiency. In particular, since the power receiving device 1 uses the receiving antenna group with the highest power reception efficiency selected from the first antenna group 2a and the second antenna group 2b respectively having different directivities, it is possible to suppress the influence of the orientation of the receiving antenna group of the power receiving device 1 relative to the power transmission device 8 and improve the power reception efficiency, as compared to when using at least one of antennas having the directivity in the same direction. The power receiving device 1 switches between antenna groups and receives the

microwave 81 with the advantageous antenna group. Therefore, a decrease in the power reception efficiency can be suppressed even if the relative positions of the power receiving device 1 and the power transmitting device 8 change, as compared to when not switching.

The first antenna group 2a and the second antenna group 2b are arranged on the housing 10 so that the back surfaces 21b with lower power reception efficiency than the surface 21a face each other. Therefore, the power receiving device 1 can receive the microwave 81 by the surface 21a with high power reception efficiency and the power reception efficiency can be improved, as compared to the case where this configuration is not adopted.

Since the power receiving device 1 can judge the advantage and disadvantage of the antenna group to be used without relying on the judgment of the power transmitting device 8, the power transmitting device 8 does not need to memorize the positions, etc., of the antenna groups of the power receiving device 1, which makes it possible to use a variety of power receiving devices 1 and enhances expandability of the power transmission system 9, as compared to the case where this configuration is not adopted.

Since the power receiving device 1 uses the thin and highly efficient patch antennas 21, it is possible to obtain higher power reception efficiency than when other antennas are used.

In searching for the receiving antenna group, the power receiving device 1 ends the search when the power converted from the microwave 81 received by the antenna group which transmitted the beacon signal 12 is not less than the threshold value 70, which saves time and suppresses power consumption as compared to the case where the receiving antenna group is determined after performing a brute-force search.

Since the power receiving device 1 performs the search starting with an advantageous antenna group which had a large power value at the time of previous charging, the search time is shortened as compared to the case where this configuration is not adopted. Particularly when there is no change in the relative positions of the power receiving device 1 and the power transmitting device 8, the power receiving device 1 takes less time to search for the receiving antenna group, power consumption is suppressed, and the time required for charging is reduced.

### Second Embodiment

The second embodiment differs from other embodiments in that the antenna group is composed of plural antennas.

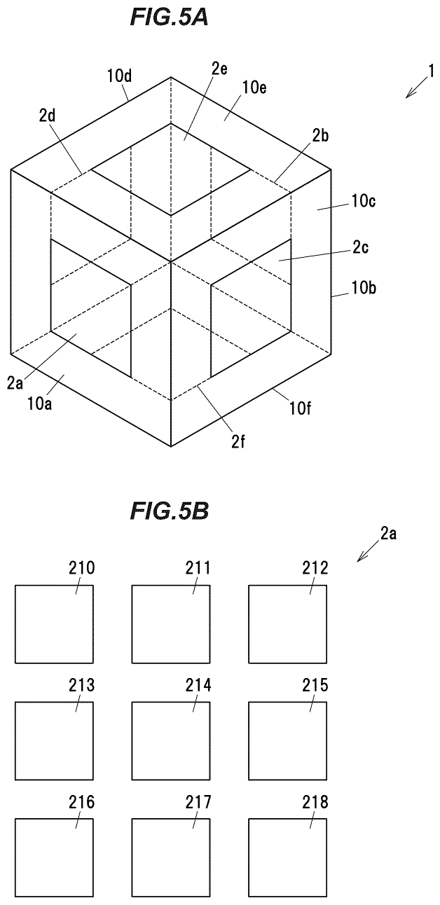

FIG. 5A is a diagram illustrating an example of the power receiving device in the second embodiment, and FIG. 5B is a diagram illustrating an example of plural antennas constituting an antenna group. In the embodiments described below, portions having the same functions and configurations as those in the first embodiment are denoted by the same reference numerals as those in the first embodiment and the explanation thereof will be omitted.

As shown in FIG. 5A, the housing 10 in the second embodiment is configured as a hexahedron. This housing 10 has first to sixth faces 10a to 10f. The first face 10a is opposite to the second face 10b, the third face 10c is opposite to the fourth face 10d, and the fifth face 10e is opposite to the sixth face 10f.

First to sixth antenna groups 2a to 2f are arranged on the first to sixth faces 10a to 10f. The first antenna group 2a is opposite to the second antenna group 2b, the third antenna group 2c is opposite to the fourth antenna group 2d, and the fifth antenna group 2e is opposite to the sixth antenna group 2f. Therefore, the first to sixth antenna groups 2a to 2f respectively have different directivities.

As an example, each of the first to sixth antenna groups 2a to 2f includes first to ninth antennas 210 to 218, as shown in FIG. 5B. The first to ninth antennas 210 to 218 are configured as patch antennas as an example, but are not limited thereto.

The communication unit 4 is configured to transmit the beacon signal 12 using at least one of the antennas in the antenna group. Since each of the first to sixth antenna groups 2a to 2f in the second embodiment has the first to ninth antennas 210 to 218, at least one of the first to ninth antennas 210 to 218 is used to transmit the beacon signal 12. As an example, the beacon signal 12 is transmitted from the fifth antenna 214 which is located at the center of the nine antennas. In other words, the beacon signal 12 is transmitted from the fifth antennas 214 of the first to sixth antenna groups 2a to 2f, as an example.

The switching unit 3 connects the communication unit 4 to the fifth antenna 214 of a target antenna group when transmitting the beacon signal 12 and connects the communication unit 4 to the first to ninth antennas 210 to 218 of the target antenna group when receiving the microwave 81.

The housing 10 is a hexahedron, but is not limited thereto and may be another polyhedron. In addition, the antenna groups are not limited to having the same number of antennas, and may each have a different number of antennas.

Here, the control unit 7 is configured such that when there is an antenna group with a power value of not less than the predetermined threshold value 70 in searching for the receiving antenna group, the control unit 7 does not perform the search on all of the plural antenna groups and sets this antenna group with a power value of not less than the predetermined threshold value 70 as the receiving antenna group.

For example, in case of transmitting the beacon signal 12 in the order of the first to sixth antenna groups 2a to 2f and when the fourth antenna group 2d receives the microwave 81 to be not less than the threshold value 70, the control unit 7 sets the fourth antenna group 2d as the receiving antenna group without transmitting the beacon signal 12 from the fifth antenna group 2e.

As a modification, the control unit 7 may set, as the receiving antenna group, an antenna group from which the highest power value is obtained, among the power values obtained by converting the microwaves 81 received by all the antenna groups.

### Effects of the Second Embodiment

Since the power receiving device 1 in the second embodiment includes plural antenna groups respectively having different directivities, the power receiving device 1 can efficiently receive the microwave 81 even if its position relative to the power transmitting device 8 changes, and the power reception efficiency can thereby be improved, as compared to the case where this configuration is not adopted.

The power receiving device 1 sets the antenna group, which is the first to exhibit a power value of not less than the threshold value 70, as the receiving antenna group. Therefore, even when there are many antenna groups, it is possible to save time and suppress power consumption, as compared to when performing a brute-force search.

Since the power receiving device 1 performs the search for the receiving antenna group in order starting from the antenna groups opposite to each other, it is possible to efficiently search for the receiving antenna group, as compared to the case where this configuration is not adopted.

In the power receiving device 1, not less than one antenna is used for both transmission of the beacon signal 12 and reception of the microwave 81. Therefore, there is no need to use an antenna for outputting the beacon signal 12 or to make all of the antennas serve for both purposes and it is thus efficient, as compared to the case where this configuration is not adopted.

### Third Embodiment

The third embodiment differs from other embodiments in that the determined receiving antenna group is reviewed.

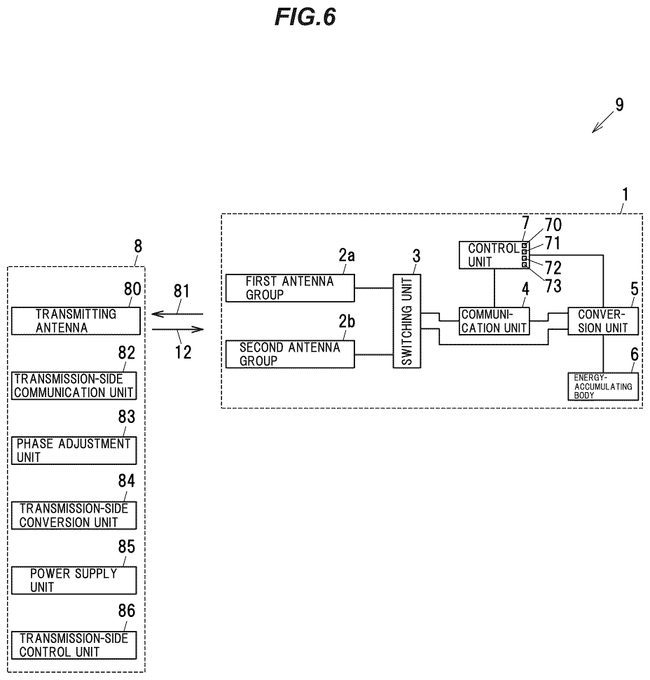

FIG. 6 is an example of a block diagram illustrating the power transmission system in the third embodiment.

The control unit 7 in the third embodiment is configured such that when a predetermined condition for reviewing the receiving antenna group is satisfied after determining the receiving antenna group, the control unit 7 searches for another receiving antenna group. As shown in FIG. 6, the control unit 7 has condition information 73 related to this condition.

Examples of this predetermined condition include the case where the power consumption of the power receiving device 1 becomes greater than the power value obtained from the received microwave 81, the case where the power value decreases by a predetermined percentage compared to the power value when the receiving antenna group is set, the case where the microwave 81 from the power transmitting device 8 cannot be received, the case where retransmission of the beacon signal 12 is requested by the power transmitting device 8, the case where the control unit 7 is configured to periodically review the receiving antenna group, and the case where the review of the receiving antenna group is instructed by a user's operation, etc.

In the case where the power consumption of the power receiving device 1 becomes greater than the power value obtained from the received microwave 81, comparison is performed between the average values of power consumption and power value over a predetermined period of time, as an example. However, it is not limited thereto.

In case where the power value decreases by a predetermined percentage compared to the power value when the receiving antenna group is set, it is determined based on the amount of change in the obtained power value or its absolute value, as an example. However, it is not limited thereto.

In the case where the microwave 81 from the power transmitting device 8 cannot be received, it is determined based on the length of time that reception is not possible, as an example. However, it is not limitied thereto.

### Effects of the Third Embodiment

After the receiving antenna group is determined, the power receiving device 1 in the third embodiment reviews the receiving antenna group based on the condition information 73. Therefore, even if there is a change in the situation, such as a change in the relative positions of the power transmitting device 8 and the power receiving device 1, a decrease in the power reception efficiency can be suppressed as compared to when continuously using the determined receiving antenna group.

### Fourth Embodiment

The fourth embodiment differs from other embodiments in that the search for the receiving antenna group is performed starting with antenna groups opposite to each other.

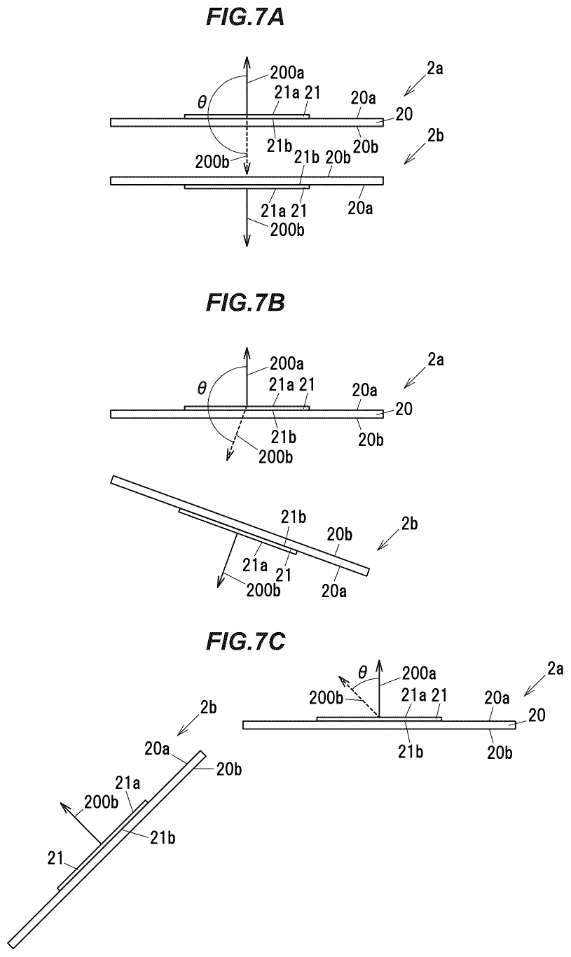

FIGS. 7A and 7B are diagrams illustrating an example of antenna groups opposite to each other in the fourth embodiment, and FIG. 7C is a diagram illustrating an example in which the antenna groups are not opposite to each other. In FIGS. 7A to 7C, a normal 200b is moved to show an angle θ and is indicated by a dotted line.

The control unit 7 in the fourth embodiment is configured such that when not less than three antenna groups are included as the plural antenna groups and there is a combination of antenna groups in which a smaller of angles formed by normals indicating the directivities of the antenna groups is more than 90° and not more than 180°, the control unit 7 sequentially transmits the beacon signal 12 starting with this combination of antenna groups. FIGS. 7A to 7C show two of not less than three antenna groups.

In particular, when the first antenna group 2a and the second antenna group 2b are arranged so that their back surfaces 21b are opposite to each other as shown in FIG. 7A, the angle θ is 180°, where the angle θ is the smaller of the angles formed between a normal 200a to the first antenna group 2a and the normal 200b to the second antenna group 2b.

Then, when the angle between the back surfaces 21b of the patch antennas 21 is an acute angle as shown in FIG. 7B, the angle θ is more than 90° and not more than 180°, where the angle θ is the smaller of the angles formed between the normal 200a to the first antenna group 2a and the normal 200b to the second antenna group 2b.

In this way, since the first antenna group 2a and the second antenna group 2b shown in FIGS. 7A and 7B are opposite to each other, the beacon signal 12 is first transmitted from the first antenna group 2a and the second antenna group 2b when there are no other antenna groups opposite to each other.

Furthermore, in FIG. 7C, the angle θ between the normal 200a to the first antenna group 2a and the normal 200b to the second antenna group 2b is not more than 90°. Therefore, the first antenna group 2a and the second antenna group 2b are not regarded as being opposite to each other.

The control unit 7 has information on these antenna groups opposite to each other as the antenna information 72. When antenna groups opposite to each other exists, the control unit 7 first outputs the beacon signal 12 from these antenna groups opposite to each other to search for the receiving antenna group.

### Effects of the Fourth Embodiment

The power receiving device 1 in the fourth embodiment performs the search for the power receiving antenna starting with antenna groups opposite to each other. In this case, when the power reception efficiency of one of the antenna groups is low, the power reception efficiency of the other antenna group is likely to be high, hence, the time required to set the receiving antenna group can be reduced, as compared to the case where this configuration is not adopted.

### Fifth Embodiment

The fifth embodiment differs from other embodiments in that plural antenna groups are further divided into plural antenna subgroups to search for the receiving antenna group.

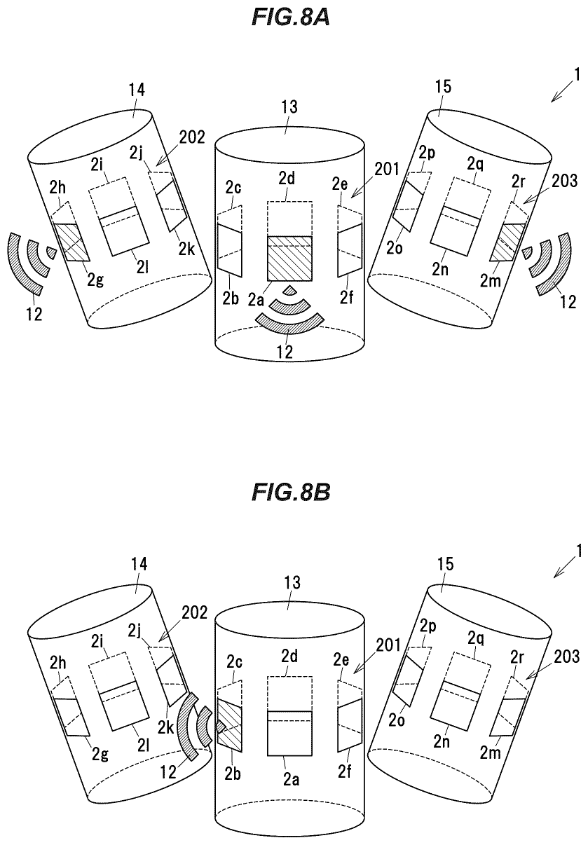

FIGS. 8A and 8B are diagrams illustrating an example of plural combination groups of the power receiving device in the fifth embodiment. In FIG. 8A, transmission of the beacon signal 12 is performed for each of three combination groups. In FIG. 8B, transmission of the beacon signal 12 is performed for each of antenna groups included in one combination group determined to be advantageous. In FIGS. 8A and 8B, the antenna groups transmitting the beacon signals 12 are hatched with diagonal lines.

The plural antenna groups in the fifth embodiment are divided into plural combination groups each of which is a combination of antenna groups. The control unit 7 transmits the beacon signal 12 for each of the plural combination groups to search for a combination group with a large power value among the plural combination groups, and further transmits the beacon signal 12 for each of antenna groups included in the searched combination group to search for the receiving antenna group.

As shown in FIGS. 8A and 8B, the power receiving device 1 has first to third housings 13 to 15. The first to third housings 13 to 15 each have a cylindrical shape, as an example. The first to third housings 13 to 15 have plural antenna groups arranged in a row on the side surface, but it is not limited thereto.

The first housing 13 has first to sixth antenna groups 2a to 2f. A first combination group 201 is composed of the first to sixth antenna groups 2a to 2f, as an example.

The second housing 14 has seventh to twelfth antenna groups 2g to 21. A second combination group 202 is composed of the seventh to twelfth antenna groups 2g to 21, as an example.

The third housing 15 has thirteenth to eighteenth antenna groups 2m to 2r. A third combination group 203 is composed of the thirteenth to eighteenth antenna groups 2m to 2r, as an example.

The control unit 7 stores information on the antenna groups constituting the first to third combination groups 201 to 203 as the antenna information 72.

Sequentially performing the search for the receiving antenna group starting from the first antenna group 2a to the eighteenth antenna group 2r takes time and also consumes large power. Therefore, the power receiving device 1 divides antenna groups into combination groups each composed of antenna groups, and first transmits the beacon signal 12 for each combination group to search for a combination group with a large power value. Then, the power receiving device 1 further transmits the beacon signal 12 for each of the antenna groups constituting the combination group with a large power value, and sets the antenna group with a large power value as the receiving antenna group. The search for the receiving antenna group may be configured to further divide plural antenna groups into plural divisions and to transmit the beacon signal 12 for each combination group for each division to search for the receiving antenna.

As an example, the control unit 7 transmits the beacon signal 12 from, e.g., the first antenna group 2a of the first combination group 201, the seventh antenna group 2g of the second combination group 202, and the thirteenth antenna group 2m of the third combination group 203, as shown in FIG. 8A. The transmission of the beacon signals 12 is performed in the order of the first to third combination groups 201 to 203, as an example.

As an example, when the value of the power converted from the microwave 81 received by the first combination group 201 is not less than the threshold value 70 and is the largest among the first to third combination group 201 to 203, the control unit 7 performs the search for the receiving antenna group starting with an antenna group of the first combination group 201, as shown in FIG. 8B.

Since the first antenna group 2a has already received the microwave 81, the control unit 7 transmits the beacon signal 12 sequentially from the second antenna group 2b to the sixth antenna group 2f which constitute the first combination group 201, stores as the power value information 71, and compares against the threshold value 70. Then, the control unit 7 starts charging the energy-accumulating body 6 by using the antenna group with a power value which is not less than the threshold value 70 and is the largest, as the receiving antenna group.

### Effects of the Fifth Embodiment

The power receiving device 1 in the fifth embodiment divides plural antenna groups into plural combination groups to search for a combination group that includes a candidate for the receiving antenna group, and performs the search for the receiving antenna group on the searched combination group. Therefore, it is possible to reduce the time required for the search and suppress the power consumption, as compared to when searching for the receiving antenna group in a brute-force manner.

According to the power receiving device 1 in at least one of the embodiments described above, it is possible to improve the power reception efficiency.

The power receiving device 1 in the embodiments and modifications described above may be partially realized by, e.g., a program executed by a computer, an ASIC (Application Specific Integrated Circuit), and an FPGA (Field Programmable Gate Array), etc., depending on the application.

Although some embodiments and modifications of the invention have been described, these embodiments and modifications are merely examples and the invention according to claims is not to be limited thereto. These new embodiments and modifications may be implemented in various other forms, and various omissions, substitutions and changes, etc., can be made without departing from the gist of the invention. In addition, not all combinations of the features described in the embodiments and modifications are necessary to solve the problem of the invention. Further, these embodiments and modifications are included within the scope and gist of the invention and also within the invention described in the claims and the range of equivalency.

### REFERENCE SIGNS LIST

1 POWER RECEIVING DEVICE
2a-2r FIRST TO EIGHTEENTH ANTENNA GROUPS
3 SWITCHING UNIT
4 COMMUNICATION UNIT
5 CONVERSION UNIT
6 ENERGY-ACCUMULATING BODY
7 CONTROL UNIT
8 POWER TRANSMITTING DEVICE
9 POWER TRANSMISSION SYSTEM
10 HOUSING
10a-10f FIRST TO SIXTH FACES
12 BEACON SIGNAL
13-15 FIRST TO THIRD HOUSINGS
20 SUBSTRATE
20a FRONT SURFACE
20b BACK SURFACE
21 PATCH ANTENNA
21a FRONT SURFACE
21b BACK SURFACE
22 FIRST ANTENNA
23 SECOND ANTENNA
70 THRESHOLD VALUE
71 POWER VALUE INFORMATION
72 ANTENNA INFORMATION
73 CONDITION INFORMATION
80 TRANSMITTING ANTENNA
81 MICROWAVE
82 TRANSMISSION-SIDE COMMUNICATION UNIT
83 PHASE ADJUSTMENT UNIT
84 TRANSMISSION-SIDE CONVERSION UNIT
85 POWER SUPPLY UNIT
86 TRANSMISSION-SIDE CONTROL UNIT
100 FRONT SURFACE
101 BACK SURFACE
200a, 200b NORMAL
201-203 FIRST TO THIRD COMBINATION GROUPS
210-218 FIRST TO NINTH ANTENNAS

1. A power receiving device, comprising:
a plurality of antenna groups each comprising at least one antenna to receive a power transmission signal transmitted for contactless power transfer from a power transmitting device and respectively having different directivities;
a transmitter that transmits a beacon signal to the power transmitting device for each of the plurality of antenna groups;
a switching unit that switches to a receiving antenna group to receive the power transmission signal that is selected from the plurality of antenna groups; and
a control unit that controls the transmitter and the switching unit, searches for the receiving antenna group for which a power value obtained by converting the power transmission signal transmitted from the power transmitting device based on the transmission of the beacon signal for each of the plurality of antenna groups is not less than a predetermined threshold value, retransmits the beacon signal corresponding to the searched receiving antenna group, and charges a charging target by receiving the power transmission signal transmitted toward the receiving antenna group.

2. The power receiving device according to claim 1, wherein when there is an antenna group with a power value of not less than the predetermined threshold value in searching for the receiving antenna group, the control unit does not perform the search on all of the plurality of antenna groups and sets the antenna group with a power value of not less than the predetermined threshold value as the receiving antenna group.

3. The power receiving device according to claim 2, wherein the control unit stores the power values obtained from the power transmission signals received by the plurality of antenna groups, and when searching for the receiving antenna group, transmits the beacon signal from the antenna group that had the largest power value at the time of previous charging.

4. The power receiving device according to claim 1, wherein when not less than three antenna groups are included as the plurality of antenna groups and there is a combination of antenna groups in which a smaller of angles formed by normals indicating the directivities of the antenna groups is more than 90° and not more than 180°, the control unit sequentially transmits the beacon signal starting with this combination of antenna groups.

5. The power receiving device according to claim 1, wherein when a predetermined condition for reviewing the receiving antenna group is satisfied after determining the receiving antenna group, the control unit searches for another receiving antenna group.

6. The power receiving device according to claim 1, wherein the plurality of antenna groups are divided into a plurality of combination groups each comprising a combination of antenna groups, and wherein the control unit transmits the beacon signal for each of the plurality of combination groups to search for a combination group with a large power value among the plural combination groups, and further transmits the beacon signal for each of antenna groups included in the searched combination group to search for the receiving antenna group.

7. The power receiving device according to claim 1, wherein the transmitter transmits the beacon signal comprising information indicating that the signal is for searching for the receiving antenna group.

8. The power receiving device according to claim 1, wherein the transmitter transmits the beacon signal using the at least one antenna in an antenna group.
